(19) United States
(12) Patent Application Publication
(10) Pub. No.: US 2026/0130479 A1
(43) Pub. Date: May 14, 2026

(54) MODULAR BAG

(71) Applicant: CIRK-L AB, Malmö (SE)

(72) Inventor: Christian AHL, Malmö (SE)

(21) Appl. No.: 19/120,821

(22) PCT Filed: Oct. 13, 2023
(86) PCT No.: PCT/EP2023/078541

§ 371 Date: Apr. 14, 2025

(30) Foreign Application Priority Data
Oct. 14, 2022 (EP) 22201632.1

(51) Int. Cl. A45C 7/00; A45C 13/02; B25H 3/00

(52) U.S. Cl. CPC A45C 7/009; A45C 13/02; B25H 3/00; A45C 2013/026

(57) ABSTRACT

A modular bag has: at least two opposite walls forming at least one compartment; a plurality of vertically extending channels on opposite internal sides of the walls, the channels formed by vertically extending, spaced seams, which are on one of the opposite internal sides aligned with the vertically extending seams on the other internal side; and at least one divider element comprising a divider portion dividing the compartment into sub-compartments and two flap portions inserted into the channels of the opposite internal sides of the at least one compartment. The divider portion has a vertically extending first end oriented towards an internal side of one of the walls and a vertically extending second end oriented towards the other internal side of the walls in an inserted position. The two flap portions extend substantially perpendicularly from the first and second ends of the divider portion in the inserted position.

### CROSS-REFERENCE TO RELATED APPLICATIONS

This application is the U.S. National Stage of PCT/EP2023/078541 filed Oct. 13, 2023, which claims priority to European Patent Application No. 22201632.1, filed Oct. 14, 2022, the content of both of which are incorporated herein by reference in their entirety.

### FIELD OF THE INVENTION

The present disclosure relates to a modular bag having a plurality of configurable sub-compartments.

### BACKGROUND OF THE INVENTION

Craftsmen, such as carpenters and electricians, often carry a tool belt or pouch that is integrated in their workwear or can be attached to the workwear. These pouches can be used for a wide range of items and tools having various sizes and shapes. The pouches are provided in a range of configurations and sizes customized for certain professions or tasks. The requirements for holding the tools are typically not the same for different professions since they use different tools. Even for one user the requirements may change and depend on the specific tasks that are carried out. The same challenge exists for a number of professions and types of pouches and bags, both on an individual level, where a person may need to use the pouch or bag for several different purposes, and on a general level, where one group of users may have one requirement and another group may have other requirements. Example of such groups include police officers, photographers, craftsmen as mentioned, military staff, sportsmen etc.

It would be therefore be useful to have a pouch or bag that is more flexible and that can be re-configured by the user and used for multiple purposes.

### SUMMARY OF THE INVENTION

The present disclosure relates to a modular bag made of a flexible material, comprising:
at least two opposite walls forming at least one compartment;
a plurality of vertically extending channels on opposite internal sides of the two opposite walls, the plurality of vertically extending channels formed by vertically extending, spaced seams, the vertically extending seams on one of the opposite internal sides being aligned with the vertically extending seams on the other of the opposite internal sides; and
at least one divider element comprising a divider portion for dividing the at least one compartment into sub-compartments and two flap portions configured to be inserted into the channels of the opposite internal sides of the at least one compartment, wherein the divider portion has a vertically extending first end oriented towards one of the internal sides of the two opposite walls and a vertically extending second end oriented towards the other of the internal sides of the two opposite walls in an inserted position, and wherein the two flap portions extend substantially perpendicularly from the first and second ends of the divider portion in the inserted position.

By being able to move the divider element to change the configurations of sub-compartments in the bag, the user can easily reconfigure the bag to be useful for a number of tools and items.

FIG. 1 shows an embodiment of the presently disclosed modular bag (100). The divider elements (108) have a divider portion (101) and two flap portions (102) that are inserted into vertically extending channels (104) on opposite internal sides of the two opposite walls (103). The divider elements (108) can be moved to other vertically extending channels (104) to reconfigure the sub-compartments (108) of the modular bag (100).

Both the divider portion and the two flap portions may be made of elongate sheets and are, preferably, made of a, preferably, substantially rigid material.

The vertically extending channels are formed by vertically extending, spaced seams. The vertically extending channels may require two layers in each opposite wall. This can be done by adding a horizontally extending strap, made of, for example, textile or a polymer on the internal side of the walls. It is also be achieved by having two two-layered walls, wherein each vertically extending channel has a cutout in an inner layer through which one flap portion can be inserted.

The modular bag may comprise two or more main compartments. The two main compartments can be separated by a third compartment wall, wherein both main compartments have at least two opposite walls forming a compartment. Both main compartment may then have vertically extending channels and divider elements for dividing the two main compartments into sub-compartments. This may be useful for several reasons, including that the two main compartments can use the same principle but have different dimensions, which allows for, for example, smaller and lighter items in the outer main compartment and larger items in the inner main compartment.

The present disclosure further relates to a bag part of a modular bag according to any one of the preceding claims, the bag part comprising:
at least two opposite walls forming at least one compartment;
at least two horizontally extending straps arranged on opposite internal sides of the two opposite walls, wherein each of the two horizontally extending straps has vertically extending, spaced seams forming channels between the horizontally extending strap and the corresponding internal side, wherein the vertically extending seams of the two horizontally extending straps are aligned with each other.

The present disclosure further relates to a divider element of a modular bag according to any one of the preceding claims, the divider element comprising:
a divider portion, wherein the divider portion is a substantially flat, elongate primary sheet;
two flap portions, wherein the two flap portions are substantially flat, elongate secondary sheets,
wherein the divider portion and the two flap portions are separated by grooves, wherein the divider portion and the two flap portions are connected by connection portions at a top end of the divider element, wherein the divider element is foldable at the connection portions.

### BRIEF DESCRIPTION OF THE DRAWINGS

Specific embodiments of the presently disclosed modular bag are shown in the drawings. The drawings are examples of embodiments and are intended to illustrate some of the features of the presently disclosed modular bag, and are not to be construed as limiting to the presently disclosed invention.

FIG. 1 shows an embodiment of the presently disclosed modular bag.

FIG. 2 shows an upper view of an embodiment of the presently disclosed bag part of a modular bag.

FIGS. 3A-B show two embodiments of an inner view of a first wall (back wall) of an embodiment of the presently disclosed bag part of a modular bag.

FIGS. 4A-B show two embodiments of an inner view of a third compartment wall (middle wall), facing the back wall, of an embodiment of the presently disclosed bag part of a modular bag.

FIGS. 5A-B show two embodiments of an inner view of a third compartment wall (middle wall), facing the front wall, of an embodiment of the presently disclosed bag part of a modular bag.

FIGS. 6A-B show two embodiments of an inner view of a second wall (front wall) of an embodiment of the presently disclosed bag part of a modular bag.

FIG. 7 shows an outer view of a second wall (front wall) of an embodiment of the presently disclosed bag part of a modular bag.

FIG. 8 shows an embodiment of the presently disclosed divider element of a modular bag in an unfolded configuration.

FIG. 9 shows a side view of an embodiment of the presently disclosed divider element of a modular bag in a folded configuration ready to be inserted into two vertically extending channels.

FIG. 10 shows a front view of an embodiment of the presently disclosed divider element of a modular bag in a folded configuration ready to be inserted into two vertically extending channels.

FIG. 11 shows an upper view of an embodiment of the presently disclosed divider element of a modular bag in a folded configuration ready to be inserted into two vertically extending channels.

FIG. 12 shows a further embodiment of the presently disclosed divider element of a modular bag in an unfolded configuration.

FIGS. 13A-D show upper views of further embodiments of the presently disclosed divider element of a modular bag in a folded configuration ready to be inserted into two vertically extending channels.

### DETAILED DESCRIPTION OF THE INVENTION

The present disclosure relates to a modular bag comprising at least two opposite walls forming at least one compartment. A ‘bag’ shall be construed broadly as any pouch, pocket or bag that can be integrated or attached to a belt, workwear, other garment or attached to, for example, a box. The bag may also be an independent unit, such as a tool bag. A ‘pouch’ may be, for example, a tool pouch. The bag may also be a tool bag. A tool bag may typically have a handle, whereas a tool pouch more typically, however not necessarily, can be attached to a garment. In one embodiment, one or both of the at least two opposite walls are made of a flexible material. The flexible material may be, for example, a textile, such as a woven textile, or a synthetic material, such as nylon. Other materials with similar properties in terms of flexibility are possible, such as nylon, neoprene and leather. The modular bag itself may be made of a flexible material, whereas the divider elements may be made of a substantially rigid and/or stiff material. The term ‘substantially rigid’ may be seen as a structure that has an overall built-in degree of rigidity, but which does not exclude some limited flexibility. Examples of such structures are sheets, such as foldable sheets, of substantially rigid plastics or metal. If the thickness of the sheet is adapted to the dimensions of the modular bag, the structures can be rigid enough to serve as dividers but flexible enough to adapt to minor deformation of the opposite walls of the modular bag.

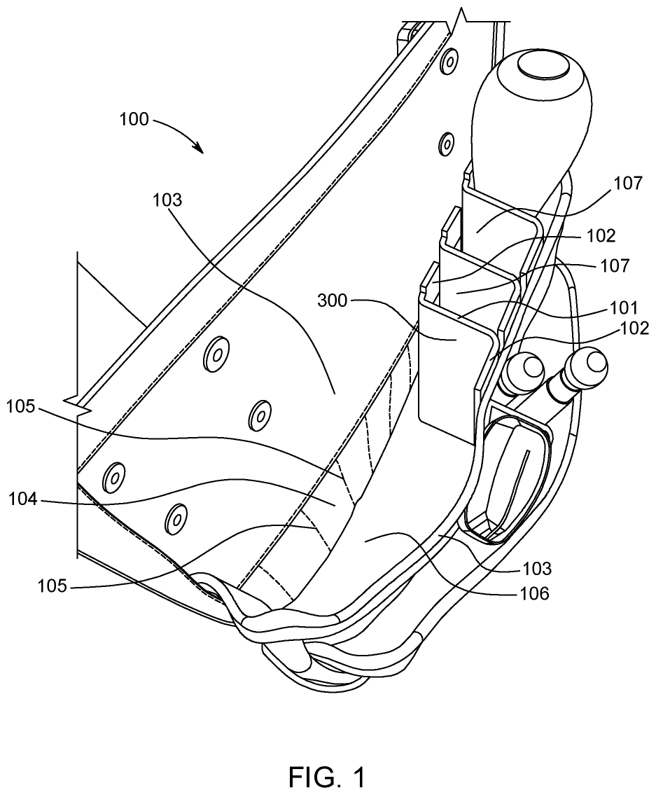

The presently disclosed modular bag may have at least two opposite wall forming sidewalls of the bag. Many variants of such bags will also include a third and a fourth sidewall forming a substantially rectangular or square compartment. A modular bag having only two walls is shown in FIG. 1. As can be seen, a first wall (103), which is back panel, and an opposite second wall (103), which is a front panel, from the compartment (106) in this example. In this example the back panel is substantially rigid, whereas the front panel is made of a more flexible material. As would be understood by a person skilled in the art, the main compartment of the bag can be made in a number of ways.

The presently disclosed modular bag comprises a plurality of vertically extending channels on opposite internal sides of the two opposite walls, wherein the plurality of vertically extending channels are formed by vertically extending, spaced seams. The vertically extending seams on one of the opposite internal sides are aligned with the vertically extending seams on the other of the opposite internal sides. The term ‘vertical’ within the present disclosure refers to a direction from a top end of the modular bag, from which tools or other items are normally inserted, towards a bottom end of the modular bag. The term ‘seam’ within the present disclosure shall be construed broadly to comprise seams obtained by a thread, but, as would be understood by a person skilled in the art, other suitable fastening, such as glued seams, rivets or the like. The bottom end of the bag may be an open end or a closed end. A modular bag according to the present disclosure is normally worn with the top end oriented upwards towards the head of the user, and the bottom end downwards towards the ground. The plurality of vertically extending channels may be integrated into the at least two opposite walls, such that they do not protrude from the at least two opposite walls. This can be achieved, for example, by having two layers wherein each vertically extending channel has a cutout in an inner layer through which one flap portion can be inserted. Alternatively, horizontally extending straps may be arranged on opposite internal sides of the two opposite walls, wherein each of the two horizontally extending straps has vertically extending, spaced seams forming the channels. The at least two horizontally extending straps may be made of an elastic material. The vertically extending channels being integrated into the at least two opposite walls may contribute to the overall slimness of the assembly.

One reason for aligning the vertically extending seams on one of the opposite internal sides are aligned with the vertically extending seams on the other of the opposite internal sides is that a certain type of divider elements can be used to divide the modular bag into a number of sub-compartments. One embodiment of the presently disclosed modular bag comprises at least one divider element comprising a divider portion for dividing the at least one compartment into sub-compartments and two flap portions configured to be inserted into the channels of the opposite internal sides of the at least one compartment. There can also be more than one divider element. The plurality of divider elements and plurality of vertically extending channels can be used to conveniently reconfigure the sub-compartments of the modular bag. Typically this will be done be introducing the two flap portions downwardly into the vertically extending channels, one of the flap portions into a vertically extending channel of one of the opposite internal sides and the other of the flap portions into a vertically extending channel of the other of the opposite internal sides.

The presently disclosed modular bag may comprise any suitable number of sub-compartments and divider elements. For example, each of the two horizontally extending straps may have at least two, or least three, or at least four and so forth vertically extending, spaced seams and at least three, at least four, or at least five and so forth possible sub-compartments. According to a further example, each of the two horizontally extending straps may have at least three vertically extending, spaced seams and at least four possible sub-compartments. The same applies for any embodiment of the vertically extending channels. Anny useful number of vertically extending channels may be used to create a modular bag with possibility of creating sub-compartments.

### Divider Elements

The divider elements are used to divide the compartment of the modular bag into sub-compartments.

The divider portion of a divider element has a vertically extending first end oriented towards one of the internal sides of the two opposite walls and a vertically extending second end oriented towards the other of the internal sides of the two opposite walls when the divider elements is in an inserted position in which it divides the at least one compartment into sub-compartments. In this position the two flap portions extend substantially perpendicularly from the first and second ends of the divider portion in the inserted position. This can be seen in several of the figures, for example, FIG. 1, in which the divider portion (101) divides compartment (106) into sub-compartments (107). The two flap portions (102) are configured in a substantially perpendicular orientation in relation to the divider portion (101). This arrangement has several advantages. One advantage is that the divider elements can be made slim.

Moreover, the divider portion and the two flap portions may form a substantially perpendicular ‘Z’ or a substantially perpendicular ‘C’. Alternatively, one or both of the two flap portions may extend in two opposite directions from the divider portion, thereby forming a ‘T’ (if one of the two flap portions extends in two opposite directions) or a ‘H’ (if one of the two flap portions extends in two opposite directions), in the inserted position. ‘Inserted position’ refers to the position in which the divider element divides the at least one compartment into sub-compartments. These shapes of the divider portion and the two flap portions may be seen as cross-sectional shapes from a top or bottom perspective. FIGS. 13A-D shows upper views of further embodiments of the presently disclosed divider element (300) in a folded configuration ready to be inserted into two vertically extending channels of two opposite walls. The embodiments of FIGS. 13A-D represent a number of possible implementations of the divider element. The divider element (300) of FIG. 13A has two flap portions (102) folded in opposite directions in a Z-shape. The divider element (300) of FIG. 13B has two flap portions (102) folded in the same direction in a C-shape. The divider element (300) of FIGS. 13A and 13B may be formed from the same sheet. The divider element (300) of FIG. 13C has two flap portions (102) wherein each flap extends in two directions from the divider portion (101) to form a rotated H-shape. The divider element (300) of FIG. 13D also has two flap portions (102) wherein each flap extends in two directions from the divider portion (101) to form a rotated H-shape. The mentioned shapes (‘Z’/‘C’/‘T’/‘H’) are not necessarily exact versions of the letters. For example, as can be seen, the ‘C’ is not a curved ‘C’ but a version of ‘C’ having three straight lines with substantially perpendicular angles. Similarly, the ‘Z’-shape referred to is a ‘Z’ having three lines with substantially perpendicular angles.

These shapes may be particularly useful when one or both of the at least two opposite walls are made of a flexible material. A bag that is at least partly made of a flexible material is inherently not fully stable. The two parallel opposite walls may get skewed as the flexible material changes. The above describe shapes can counteract instability while maintaining a slim design of the bag or pouch.

The present disclosure accordingly further relates to a divider element of a modular bag according to any one of the preceding claims, the divider element comprising:
a divider portion, wherein the divider portion is a substantially flat, elongate primary sheet;
two flap portions, wherein the two flap portions are substantially flat, elongate secondary sheets,
wherein the divider portion and the two flap portions are separated by grooves,
wherein the divider portion and the two flap portions are connected by connection portions at a top end of the divider element, wherein the divider element is foldable at the connection portions.

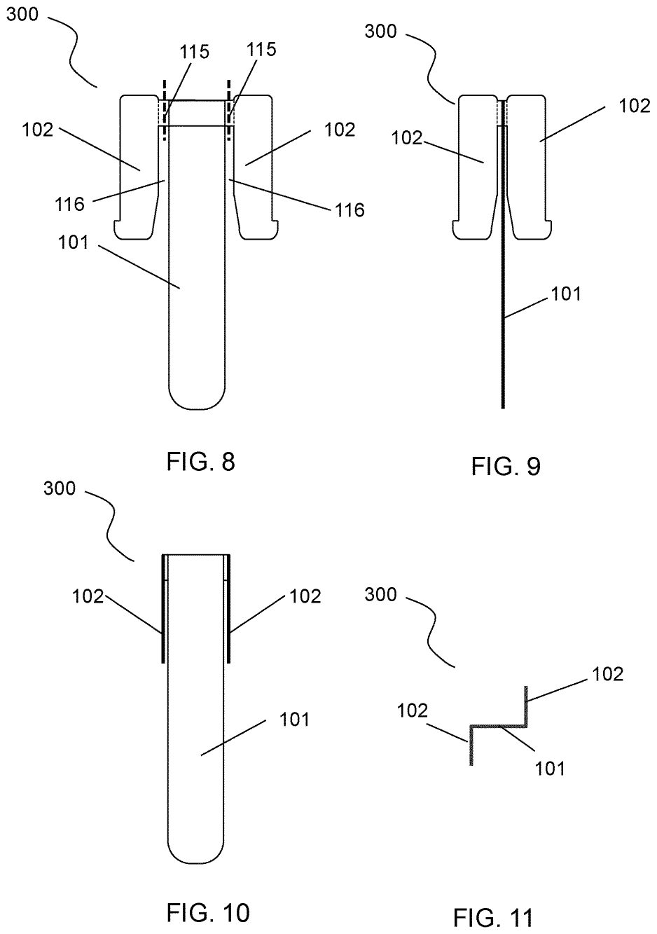

FIG. 8 shows an example of a divider element (300) comprising a divider portion (101) and two flap portions (102). In the example of FIG. 8 the divider element is provided in one sheet. The divider portion (101) and two flap portions (102) are connected to each other at connection portions (115). Preferably, the divider element (300) is foldable at the connection portions (115). The two flap portions (102) may each be folded approximately 90° relative to the divider portion (101).

The divider portion may be provided as a substantially flat sheet. As stated, the substantially flat sheet may be folded to a shape that can be used as a divider element for the presently disclosed modular bag.

The divider portion may be an elongate sheet. An example of such a sheet (101) is shown in FIG. 8. Preferably, the width of the divider portion corresponds to a distance between the two opposite walls forming the compartment. The divider portion may have a substantially rectangular shape, possibly with rounded corners.

The two flap portions may also be elongate sheets. They may have a substantially rectangular shape, possibly with rounded corners.

Both the divider portion and the two flap portions may be made of a rigid and/or stiff material, such as metal or a rigid polymer.

The two flap portions may be dimensioned to fit into the vertically extending channels of the modular bag.

The divider portion and the two flap portions may be separated by grooves, wherein the divider portion and the two flap portions are connected by connection portions at a top end of the divider element. The grooves may thereby have a closed end at the connection portions and an open end at the opposite end of the groove. the vertically extending seams can then be inserted into the grooves from the open end. An example of a divider element (300) having such grooves (116) is shown in FIG. 8. When the two flap portions (102) are inserted into the vertically extending channels of the modular bag, the vertically extending seams will be placed in the grooves (116). Preferably, the width of the two flap portions (102) is slightly less than the width of the vertically extending channels of the modular bag. FIGS. 9-11 show the example of the modular bag of FIG. 8 in a folded configuration. FIG. 9 shows a side view of the divider element (300). FIG. 10 shows a front view of the divider element (300). FIG. 11 shows an upper view of the divider element (300).

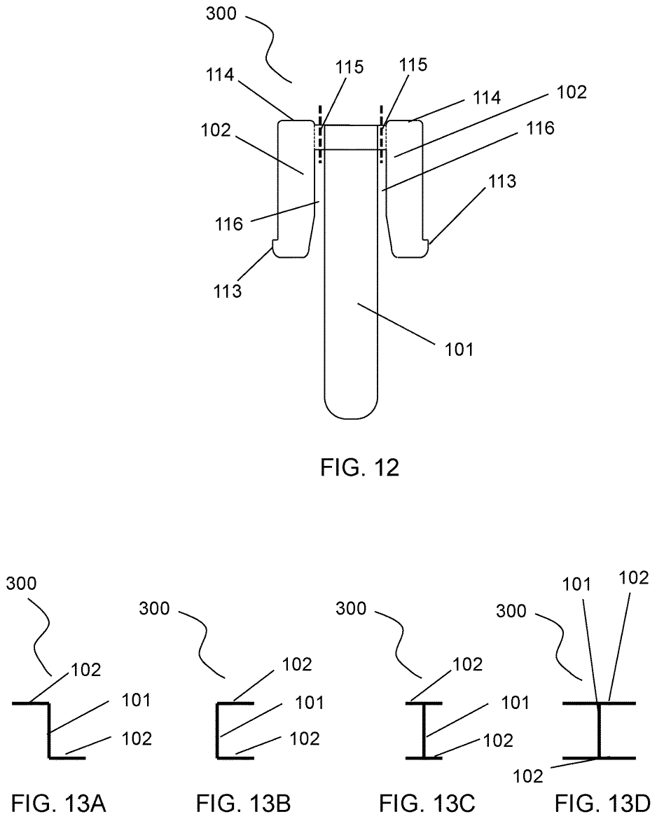

In one embodiment, each of the two flap portions has a hook, preferably on a bottom end of the flap portion, to prevent that the flaps move upwards when the flap portions are arranged in the channels. This is particularly useful if the vertically extending channels have an open bottom end, such that the hooks can be configured around bottom ends of the vertically extending seams. This can be achieved, for example, by having two horizontally extending straps with vertically extending seams forming the vertically extending channels. FIG. 12 shows an example of a divider element (300), wherein the flap portions (102) have hooks (113). The hook may be disposed on a bottom end of the flap portion but have a hook end that is oriented towards a top end of the flap portion. Alternatively the hook may have a horizontal orientation, such as a perpendicular orientation relative to the general longitudinal extension of the flap portion, when the divider is in an inserted position. The hooks on the flap portions are particularly useful for embodiments involving horizontally extending straps forming the vertically extending channels.
In one embodiment, each of the two flap portions has an upper extension. This is particularly useful if the vertically extending channels of the bag part have an upper channel in which the upper extensions can be introduced. The upper channel can be formed by an upper horizontal strap. It may also be formed by having two layers in a wall and vertically extending seams. By making a cutout in the inner layer, which is the layer towards the divider element, a vertically extending channel having both a lower section, in which a flap portion can be arranged, and an upper section, in which the upper extension can be arranged, is obtained. FIG. 12 shows an example of a divider element (300), wherein the flap portions (102) have upper extensions (114). The upper extensions may be adapted to secure the flap portions in an upper channel above the cutout.

### Bag Part

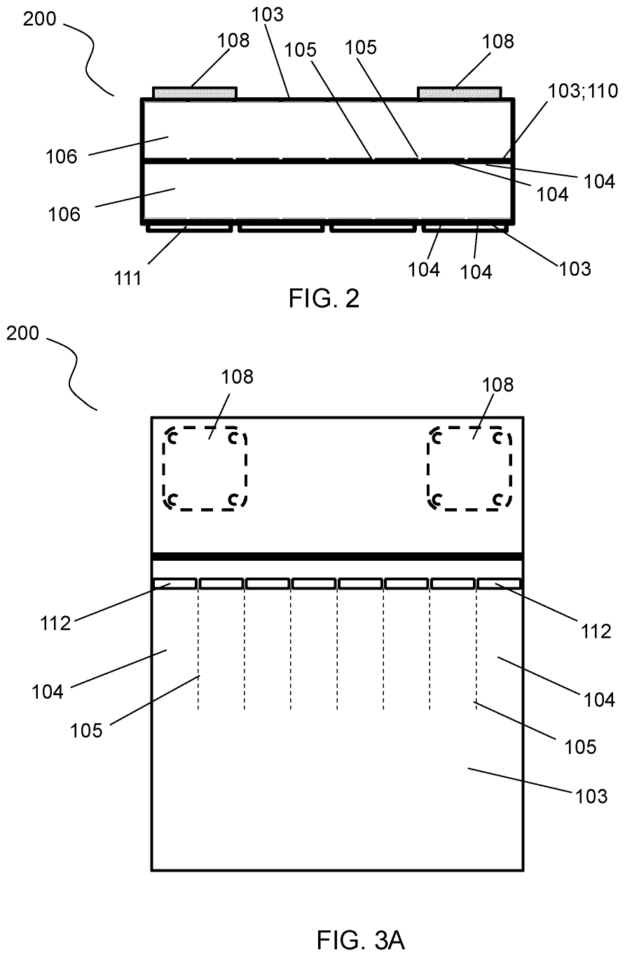

The present disclosure therefore further relates to a bag part of a modular bag according to any one of the preceding claims, the bag part comprising:
at least two opposite walls forming at least one compartment;
at least two horizontally extending straps arranged on opposite internal sides of the two opposite walls, wherein each of the two horizontally extending straps has vertically extending, spaced seams forming channels between the horizontally extending strap and the corresponding internal side, wherein the vertically extending seams of the two horizontally extending straps are aligned with each other.
FIG. 2 shows an upper view of an example of a bag part (200) of a modular bag. This particular example has two main compartments (106). There are two outer walls (103) and a third compartment wall (110). The two main compartments (106) separated by a third compartment wall (110), wherein both main compartments (106) have at least two opposite walls (103; 110) forming a compartment (106). It can be seen that the vertically extending channels (104) of opposite walls (103; 110) are aligned with each other. The example of bag part (200) shown in FIG. 2 has two optional elements: attachment elements (108) and the outer channels (111).
Preferably, the at least two opposite walls are substantially parallel. As stated above, variants of bags will also include a third and a fourth sidewall forming a substantially rectangular or square compartment, which is the case in the example of FIG. 2.
The vertically extending, spaced seams may have a distance of 5 mm to 50 mm, preferably 5 mm to 40 mm, more preferably 7 mm to 30 mm, such as 10 mm or 20 mm, between the seams. The distance between the vertically extending, spaced seams can generally be said to define the widths of the vertically extending channels. The distance may be adapted to the size of the modular bag and other requirements.

Two examples of ways of obtaining the vertically extending channels include horizontally extending straps and using two layers in the opposite walls wherein each vertically extending channel has a cutout in an inner layer of the two layers through which one flap portion can be inserted.

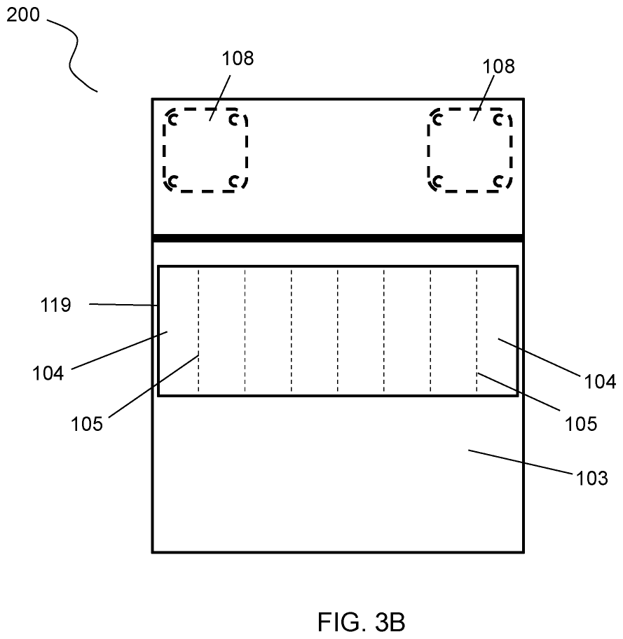

In one embodiment the bag part comprises at least two horizontally extending straps arranged on opposite internal sides of the two opposite walls, wherein each of the two horizontally extending straps has vertically extending, spaced seams forming the channels. The at least two horizontally extending straps may be, for example, textile straps or polymer straps, such as nylon straps, or any other suitable strap. The at least two horizontally extending straps may have a height greater than 30 mm, preferably greater than 60 mm, more preferably greater than 80 mm. The height of the horizontally extending straps can be said to define the length of the vertically extending channels.
One embodiment the bag part has opposite walls that are made of two layers. The inner layer of such a wall may be referred to as the layer facing the compartment in which the divider element can be placed. Vertically extending, spaced seams that attach the two layers form channels between the two layers. In one embodiment of the presently disclosed bag part, each of the vertically extending channels has a cutout in the inner layer through which one flap portion can be inserted. In the example of. FIG. 3A, which shows an inner view of a first wall (back wall) of an embodiment of the presently disclosed bag part (200) of a modular bag, wherein the vertically extending channels have cutouts in the inner layer, there are 8 vertically extending channels (104) and 8 cutouts (112). FIG. 3B shows an alternative variant of the bag part (200) of a modular bag, wherein a horizontally extending strap (119) with vertically extending, spaced seams (105) form the channels (104). A flap portion can be inserted to any of the cutouts (112) and placed in any of the channels (104). The cutouts may have, for example, a substantially rectangular shape. The embodiments that are conceptually shown in FIGS. 3A-B can be part of any of the walls. The examples of bag part (200) shown in FIGS. 3A-B has optional attachment elements (108).

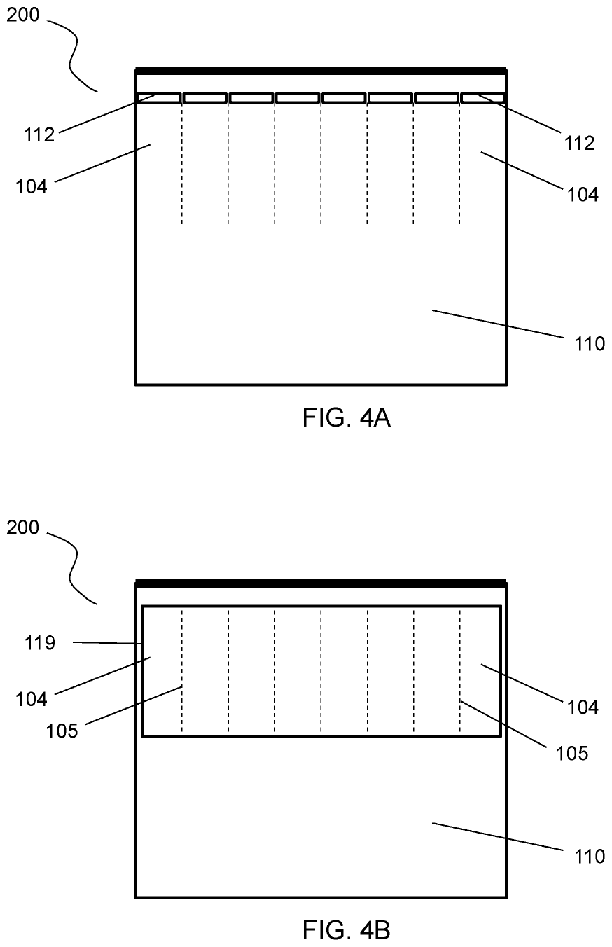

FIG. 4A shows an inner view of a third compartment wall (middle wall) (110), facing the back wall, of an embodiment of the presently disclosed bag part (200) of a modular bag. The 8 cutouts (112) correspond to the 8 cutouts of the back wall of FIG. 3. FIG. 4B shows an alternative variant of the bag part (200) of a modular bag, wherein a horizontally extending strap (119) with vertically extending, spaced seams (105) form the channels (104).

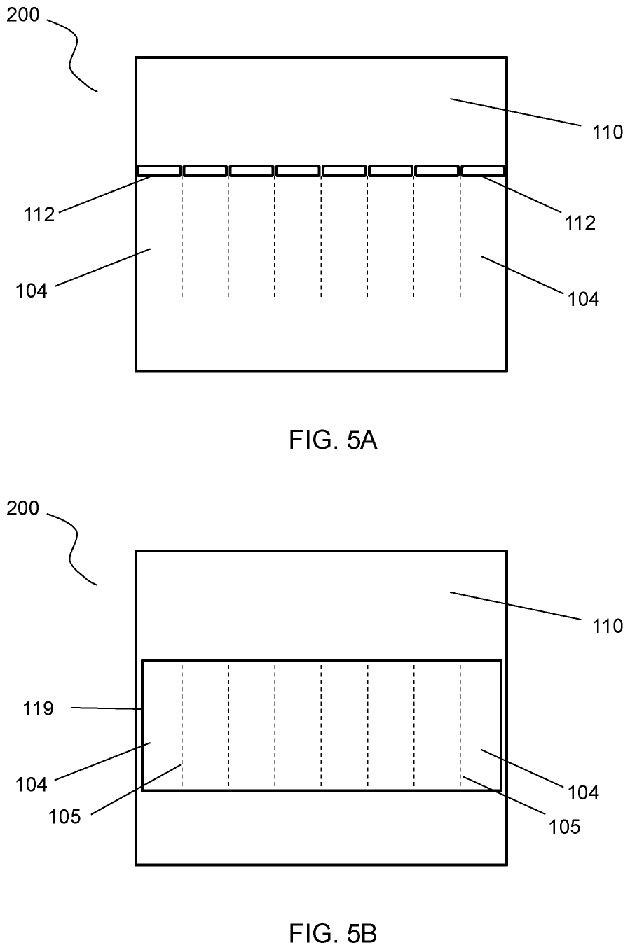

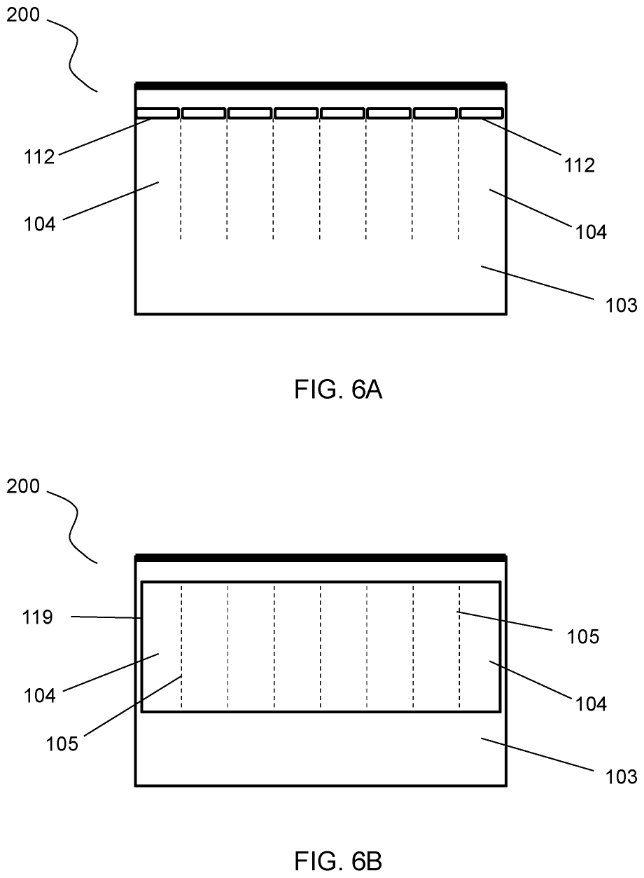

FIG. 5A shows an inner view of a third compartment wall (middle wall) (110), facing the front wall, of an embodiment of the presently disclosed bag part (200) of a modular bag. FIG. 5B shows an alternative variant of the bag part (200) of a modular bag, wherein a horizontally extending strap (119) with vertically extending, spaced seams (105) form the channels (104). FIG. 6A shows an inner view of a second wall (front wall) (103) of an embodiment of the presently disclosed bag part (200) of a modular bag. The 8 cutouts (112) of the third compartment wall (middle wall) (110) in FIG. 5A correspond to the 8 cutouts of the back wall (103) of FIG. 6A. FIG. 6B shows an alternative variant of the bag part (200) of a modular bag, wherein a horizontally extending strap (119) with vertically extending, spaced seams (105) form the channels (104).

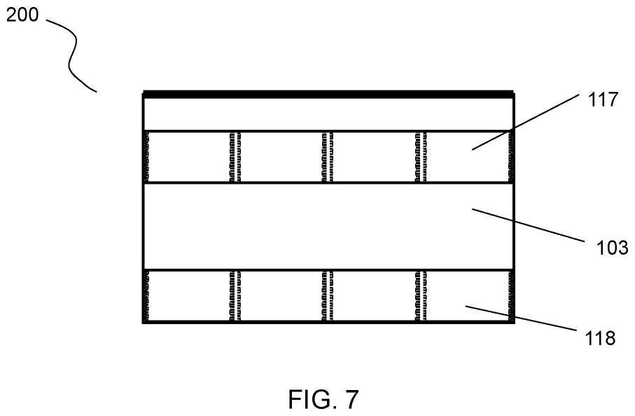

The presently disclosed bag part may further comprise an upper strap with vertically extending, spaced seams forming outer channels arranged on the outside of the modular bag. The bag part may further comprise a lower strap with vertically extending, spaced seams forming outer channels arranged on the outside of the modular bag. FIG. 7 shows an outer view of a second wall (front wall) (103) of an embodiment of the presently disclosed bag part (200) of a modular bag having an upper strap (117) and a lower strap (118).

The presently disclosed bag part may further comprise one or more attachment elements for attaching the modular bag to a garment or an item, such as a bag.

The present disclosure further relates to a garment comprising any embodiment of the presently disclosed the modular bag. The garment may be, for example, a pair of trousers or a jacket. The modular bag may also be attached to a bag or a box. The present disclosure, accordingly, further relates to a bag or a box, such as a toolbox, comprising any embodiment of the presently disclosed the modular bag.

As stated above, the presently disclosed modular bag may be a modular pouch, such as a modular tool pouch, or a modular tool bag. Specifically, the present disclosure may therefore further relate to a modular pouch or a modular tool bag, comprising:
at least two opposite walls forming at least one compartment;
a plurality of vertically extending channels on opposite internal sides of the two opposite walls, the plurality of vertically extending channels formed by vertically extending, spaced seams, the vertically extending seams on one of the opposite internal sides being aligned with the vertically extending seams on the other of the opposite internal sides; and
at least one divider element comprising a divider portion for dividing the at least one compartment into sub-compartments and two flap portions configured to be inserted into the channels of the opposite internal sides of the at least one compartment.

### LIST OF ELEMENTS IN FIGURES

100—modular bag
101—divider portion
102—flap portion
103—wall
104—vertically extending channel
105—vertically extending seam
106—compartment
107—sub-compartment
108—attachment element
110—third compartment wall
111—outer channel
112—cutout
113—hook
upper extension
connection portion
groove
upper strap
118—lower strap
horizontal strap
bag part
divider element

### Further Details

1. A modular bag, comprising:
at least two opposite walls forming at least one compartment;
a plurality of vertically extending channels on opposite internal sides of the two opposite walls, the plurality of vertically extending channels formed by vertically extending, spaced seams, the vertically extending seams on one of the opposite internal sides being aligned with the vertically extending seams on the other of the opposite internal sides; and
at least one divider element comprising a divider portion for dividing the at least one compartment into sub-compartments and two flap portions configured to be inserted into the channels of the opposite internal sides of the at least one compartment.

2. The modular bag according to item 1, wherein the divider portion is a substantially flat sheet.

3. The modular bag according to any one of the preceding items, wherein the divider portion is an elongate sheet.

4. The modular bag according to any one of the preceding items, wherein the divider portion and the two flap portions are made of a rigid material.

5. The modular bag according to any one of the preceding items, wherein the two flap portions are dimensioned to fit into the channels.

6. The modular bag according to any one of the preceding items, wherein the two flap portions are substantially flat sheets.

7. The modular bag according to any one of the preceding items, wherein the divider portion and the two flap portions are separated by grooves, and wherein the divider portion and the two flap portions are connected by connection portions at a top end of the divider element.

8. The modular bag according to item 7, wherein the divider element is foldable at the connection portions.

9. The modular bag according to any one of the preceding items, comprising at least two horizontally extending straps arranged on opposite internal sides of the two opposite walls, wherein each of the two horizontally extending straps has vertically extending, spaced seams forming the channels.

10. The modular bag according to any one of the preceding items, wherein each of the two flap portions has a hook, preferably on a bottom end of the flap portion, to prevent that the flaps move upwards when the flap portions are arranged in the channels.

11. The modular bag according to any one of items 1-8, wherein each of the at least two opposite walls has two layers and wherein each vertically extending channel has a cutout in an inner layer through which one flap portion can be inserted.

12. The modular bag according to any one of the preceding items, wherein each of the two flap portions has an upper extension.

13. The modular bag according to items 11-12, wherein the upper extension is adapted to secure the flap portion in an upper channel above the cutout.

14. The modular bag according to any one of the preceding items, wherein the at least two opposite walls are substantially parallel.

15. The modular bag according to any one of the preceding items, comprising two main compartments separated by a third compartment wall, wherein both main compartments have at least two opposite walls forming a compartment.

16. The modular bag according to any one of the preceding items, wherein the at least two horizontally extending straps are textile straps or polymer straps, such as nylon straps.

17. The modular bag according to any one of the preceding items, wherein the vertically extending, spaced seams have a distance of 5 mm to 50 mm, preferably 5 mm to 40 mm, more preferably 7 mm to 30 mm, such as 10 mm or 20 mm, between the seams.

18. The modular bag according to any one of the preceding items, wherein the at least two horizontally extending straps have a height greater than 30 mm, preferably greater than 60 mm, more preferably greater than 80 mm.

19. The modular bag according to any one of the preceding items, further comprising an upper strap with vertically extending, spaced seams forming outer channels arranged on the outside of the modular bag.

20. The modular bag according to any one of the preceding items, further comprising a lower strap with vertically extending, spaced seams forming outer channels arranged on the outside of the modular bag.

21. The modular bag according to any one of the preceding items, further comprising one or more attachment elements for attaching the modular bag to a garment or an item, such as a bag.

22. The modular bag according to any one of the preceding items, wherein each of the two horizontally extending straps has at least two vertically extending, spaced seams and at least three possible sub-compartments.

23. The modular bag according to any one of the preceding items, wherein each of the two horizontally extending straps has at least three vertically extending, spaced seams and at least four possible sub-compartments.

24. A garment comprising the modular bag according to any one of the preceding items.

25. A bag or a box, such as a toolbox, comprising the modular bag according to any one of items 1-23.

26. A bag part of a modular bag according to any one of the preceding items, the bag part comprising:
at least two opposite walls forming at least one compartment;
at least two horizontally extending straps arranged on opposite internal sides of the two opposite walls, wherein each of the two horizontally extending straps has vertically extending, spaced seams forming channels between the horizontally extending strap and the corresponding internal side, wherein the vertically extending seams of the two horizontally extending straps are aligned with each other.

27. A divider element of a modular bag according to any one of the preceding items, the divider element comprising:
a divider portion, wherein the divider portion is a substantially flat, elongate primary sheet;
two flap portions, wherein the two flap portions are substantially flat, elongate secondary sheets,
wherein the divider portion and the two flap portions are separated by grooves,
wherein the divider portion and the two flap portions are connected by connection portions at a top end of the divider element, wherein the divider element is foldable at the connection portions.

1-20. (canceled)

21. A modular bag, comprising:
at least two opposite walls forming at least one compartment;
a plurality of vertically extending channels on opposite internal sides of the two opposite walls, the plurality of vertically extending channels formed by vertically extending, spaced seams, the vertically extending seams on one of the opposite internal sides being aligned with the vertically extending seams on the other of the opposite internal sides; and
at least one divider element comprising a divider portion for dividing the at least one compartment into sub-compartments and two flap portions configured to be inserted into the channels of the opposite internal sides of the at least one compartment, wherein the divider portion has a vertically extending first end oriented towards one of the internal sides of the two opposite walls and a vertically extending second end oriented towards the other of the internal sides of the two opposite walls in an inserted position, and wherein the two flap portions extend substantially perpendicularly from the first and second ends of the divider portion in the inserted position.

22. The modular bag according to claim 21, wherein the divider portion is a foldable substantially flat sheet.

23. The modular bag according to claim 21, wherein one or both of the at least two opposite walls are made of a flexible material.

24. The modular bag according to claim 21, wherein the divider portion and the two flap portions are made of a substantially rigid material.

25. The modular bag according to claim 21, wherein the divider portion and the two flap portions form a substantially perpendicular ‘Z’ or a substantially perpendicular ‘C’, and/or wherein one or both of the two flap portions extend in two opposite directions from the divider portion, thereby forming a ‘T’ or a ‘H’, in the inserted position.

26. The modular bag according to claim 21, wherein the two flap portions are dimensioned to fit into the channels.

27. The modular bag according to claim 21, wherein the divider portion and the two flap portions are separated by grooves, and wherein the divider portion and the two flap portions are connected by connection portions at a top end of the divider element.

28. The modular bag according to claim 27, wherein the divider element is foldable at the connection portions.

29. The modular bag according to claim 21, wherein the plurality of vertically extending channels are integrated into the at least two opposite walls and do not protrude from the at least two opposite walls.

30. The modular bag according to claim 21, comprising at least two horizontally extending straps arranged on opposite internal sides of the two opposite walls, wherein each of the two horizontally extending straps has vertically extending, spaced seams forming the channels.

31. The modular bag according to claim 30, wherein each of the two horizontally extending straps has at least two vertically extending, spaced seams.

32. The modular bag according to claim 30, wherein the at least two horizontally extending straps are made of an elastic material.

33. The modular bag according to claim 21, wherein each of the two flap portions has a hook, preferably on a bottom end of the flap portion, to prevent that the flaps move upwards when the flap portions are arranged in the channels.

34. The modular bag according to claim 33, wherein the hook has a hook end oriented towards a top end of the flap portion or in a horizontal orientation when the divider element is in an inserted position.

35. The modular bag according to claim 21, wherein each of the at least two opposite walls has two layers and wherein each vertically extending channel has a cutout in an inner layer through which one flap portion can be inserted.

36. The modular bag according to claim 21, wherein each of the two flap portions has an upper extension.

37. The modular bag according to claim 36, wherein the upper extension is adapted to secure the flap portion in an upper channel above the cutout.

38. A bag part of a modular bag, the bag part comprising:
at least two opposite walls forming at least one compartment;
at least two horizontally extending straps arranged on opposite internal sides of the two opposite walls, wherein each of the two horizontally extending straps has vertically extending, spaced seams forming channels between the horizontally extending strap and the corresponding internal side, wherein the vertically extending seams of the two horizontally extending straps are aligned with each other.

39. A divider element of a modular bag, the divider element comprising:
a divider portion, wherein the divider portion is a substantially flat, elongate primary sheet;
two flap portions, wherein the two flap portions are substantially flat, elongate secondary sheets,
wherein the divider portion and the two flap portions are separated by grooves, wherein the divider portion and the two flap portions are connected by connection portions at a top end of the divider element, wherein the divider element is foldable at the connection portions.
